(19) United States
(12) Patent Application Publication
(10) Pub. No.: US 2024/0408800 A1
(43) Pub. Date: Dec. 12, 2024

(54) THERMOFORMING THREADS IN COMPOSITE TUBING

(71) Applicant: Halliburton Energy Services, Inc., Houston, TX (US)

(72) Inventors: Michael Linley Fripp, Singapore (SG); Yian Zhao, Singapore (SG); Chad William Glaesman, Singapore (SG)

(21) Appl. No.: 18/333,263

(22) Filed: Jun. 12, 2023

(51) Int. Cl. B29C 43/02; B29C 43/36

(52) U.S. Cl. CPC B29C 43/021; B29C 43/36; B29C 2043/024; B29L 2001/00; B29L 2023/22

(57) ABSTRACT

An apparatus may include a thermoplastic composite fiber tubular to be positioned in a wellbore, the thermoplastic composite fiber tubular comprising a thermoplastic matrix, a plurality of fibers laid within the thermoplastic matrix, and one or more threads thermoformed at an end of the thermoplastic composite fiber tubular. The one or more threads, once thermoformed, may be configured to form a threaded connection with another tubular in the wellbore.

### TECHNICAL FIELD

The disclosure generally relates to tubulars and piping for use in a wellbore formed in one or more subsurface formations, and in particular, creating threaded connections between one or more of the tubulars.

### BACKGROUND

Traditional tubing joints and/or tubulars may be comprised of various grades of carbon steel and stainless steel. Standard steel production tubing is heavy and prone to corrosion in a wellbore containing one or more downhole fluids, especially hydrogen sulfide (H₂S) and hydrogen. The weight of the steel tubing may necessitate using a large, powerful rig for installations and workovers.

Some variations of composite tubing made from materials other than steel (e.g., some may be comprised of thermoset epoxy) may also be unstable in downhole fluids and conditions. Thus, tubing comprised of a less dense, less reactive material that is able to withstand the conditions in the wellbore may be beneficial. Production tubing made from a thermoplastic fiber composite would comprise a near neutral density with a wellbore fluid and may be resistant to most downhole fluids and corrosive agents such as H₂S and hydrogen. However, one of the primary challenges of composite tubing is creating threads to use in forming threaded connections between composite tubulars without damaging the pipe. Machining these threads may cut the fibers in the composite and result in substantial reductions in material strength and ply integrity.

### BRIEF DESCRIPTION OF THE DRAWINGS

Implementations of the disclosure may be better understood by referencing the accompanying drawings.

FIG. 1 is a schematic diagram depicting an example thermoplastic composite fiber tubular, according to some implementations.

FIG. 2 is a schematic diagram depicting an example thermoplastic composite fiber tubular with thermoformed threads, according to some implementations.

FIG. 3 is a schematic diagram depicting a tight view of the thermoforming process to form the threads, according to some implementations.

FIG. 4 is a schematic diagram depicting the thermoformed threads of FIG. 3, according to some implementations.

FIG. 5 is a cross-sectional diagram depicting an example wellbore comprising a tubing string partially constructed of thermoplastic composite tubing, according to some implementations.

FIG. 6A is an illustration depicting a first example threaded connection between two thermoplastic composite fiber tubulars, according to some implementations.

FIG. 6B is a schematic diagram depicting a second example threaded connection between two thermoplastic composite fiber tubulars, according to some implementations.

FIG. 7 is a schematic diagram depicting an example thermoplastic composite fiber tubular with thermoformed threads comprising various fiber orientations, according to some implementations.

FIG. 8 is a cross-sectional diagram depicting an example molded short-fiber composite, according to some implementations.

FIG. 9 is a cross-sectional diagram depicting an example molded short-fiber insert, according to some implementations.

FIG. 10 is a flowchart depicting example operations for thermoforming threads onto a thermoplastic composite fiber tubular to be used in a wellbore, according to some implementations.

### DESCRIPTION OF SOME EXAMPLE IMPLEMENTATIONS

The description that follows includes example systems, methods, techniques, and program flows that embody implementations of the disclosure. However, it is understood that this disclosure may be practiced without these specific details. In other instances, well-known instruction instances, protocols, structures, and techniques have not been shown in detail in order not to obfuscate the description.

Example implementations may include threads formed on a thermoplastic composite fiber tubular through a process of thermoforming. The thermoplastic composite fiber tubular may be constructed from strong fibers laid in layers and subsequently bound within a thermoplastic matrix. The fibers may include continuous fibers (filament wound), woven fibers, and chopped (short) fibers, although other fiber configurations may be possible. The thermoforming may form threads in the thermoplastic composite tubing without inducing damage to the composite tubing when compared to traditional methods of thread forming, such as machining. The thermoplastic composite tubing may be stable in downhole fluids and conditions, and the thermoformed threads may allow joints (individual tubulars) of thermoplastic composite fiber tubing to be coupled to one another. In some implementations, a production tubing may be constructed from a thermoplastic composite. Additionally, threads may be thermoformed into the composite with a hot mold.

Accordingly, example implementations may provide jointed composite tubing that allows the use of traditional oilfield components without the weight and without the corrosion potential attributed to a comparable steel component. An example application may include a completion tool that may use composite tubing to create sand screens and other tools in a lower completion. Additionally, with a composite lower completion, the length of the tubing that may be installed in an extended reach horizontal well may greatly increase (as compared to conventional approaches).

Thus, example implementations may include a composite tubing for completions that is composed of a low-density material causes the tubing to have a nearly neutral density in brine. Such composite tubing may enable installing a completion in an extended reach wellbore. Also, because the composite tubing is composed of a lower density material, such tubing may enable simpler installation of a lower completion with a smaller rig, via wireline, or the lower completion may be pumped into the wellbore.

### Example Thermoplastic Composite Fiber Tubular

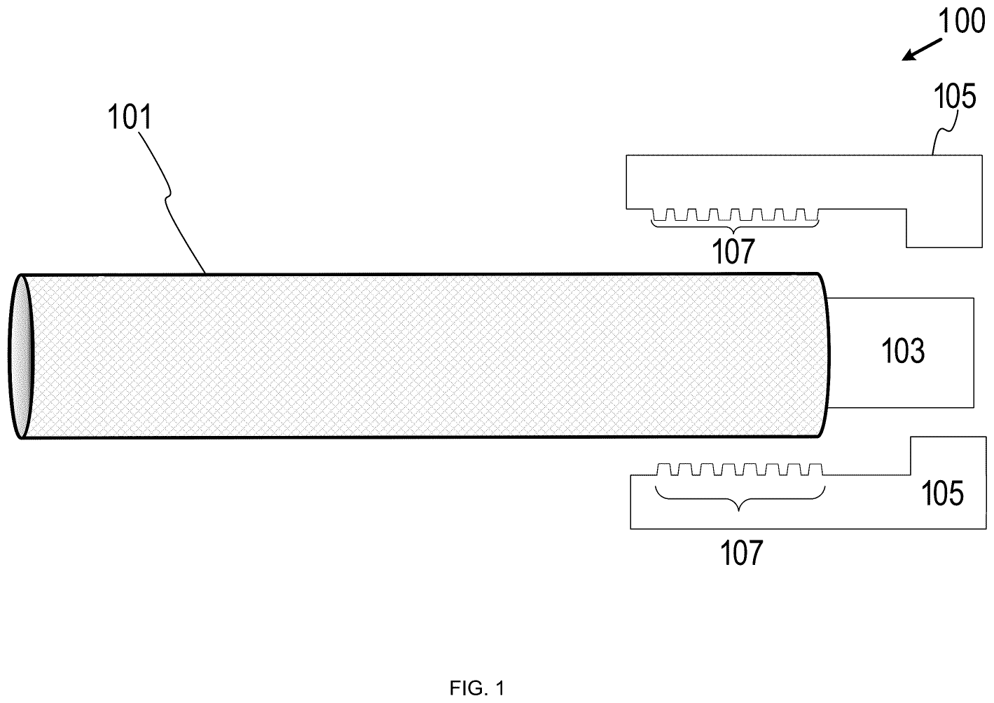

An example thermoplastic composite fiber tubular is now described. FIG. 1 is a schematic diagram 100 depicting an example thermoplastic composite fiber tubular, according to some implementations. A thermoplastic composite fiber tubular 101 may be a tubular constructed from a thermoplastic fiber composite. For example, the thermoplastic composite fiber tubular 101 may comprise one or more strong fibers oriented within a thermoplastic matrix. In some implementations, the one or more fibers may be comprised of filament wound fibers or woven fiber. For example, the thermoplastic composite fiber tubular 101 may be formed by winding fibers in different directions to form a skeleton of the tube during a pre-preparation phase. The fibers may also be laid layer by layer in a desired orientation. In some implementations, a thermoplastic composite tape may be wound around the fibers to form the exterior of the thermoplastic composite fiber tubular 101. The thermoplastic composite tape may also be used in an area reserved for the threads or adjacent to the area to be pressed by a toothed mold 107. In other implementations, the one or more fibers may be comprised of shorter. chopped fibers.

The one or more fibers within the thermoplastic composite fiber tubular 101 may be comprised of materials including, but not limited to glass, carbon, aramid, boron, basalt, metal, polyethylene, polypropylene, and polybenzoxazole (PBO). A thermoplastic binder may be used to bind the matrix to the one or more fibers. Example thermoplastic binders may include non-reactive polymers such as polyetheretherketone (PEEK), polytetrafluoroethylene (PTFE), urethanes, acrylonitrile butadiene styrene (ABS), polyamide, polyphenylene sulfide (PPS), polyethylene, polycarbonate, PVC, nylon, or other suitable non-reactive polymers. As described herein, a non-reactive polymer may refer to any polymer incapable of forming covalent bonds (sharing electrons) with other materials to an extent that would alter a physical property of the non-reactive polymer or the other material(s). In some implementations, the thermoplastic binder may be a thermoplastic elastomer, such as a thermoplastic polyurethane or a thermoplastic polyamide. The matrix may include fillers including, but not limited to carbon black, graphite, glass, silica, pigment, and nanotubes. The matrix may be applied to the one or more fibers prior to creating the thermoplastic composite fiber tubular 101 (e.g., a pre-impregnation) or during its fabrication.

The thermoplastic composite fiber tubular 101 may utilize threads on one or both ends in order to be joined to other pieces of equipment (steel production tubing, other thermoplastic composite tubulars, downhole tools, etc.). Threads in the thermoplastic composite fiber tubular 101 may be formed through a process of thermoforming. A press 105 may comprise a toothed mold 107 comprising one or more teeth used to indent threads into the thermoplastic composite fiber tubular 101. The toothed mold 107 may be heated via an external heat source or via an electrical circuit within or proximate to the press 105.

While the press 105 is depicted in FIG. 1 as a simple apparatus configured to move the toothed mold 107 towards and into the thermoplastic composite fiber tubular 101, the press 105 may comprise any suitable circumferential pressing apparatus capable of a desired precision and compressive force to thermoform the threads. For example, the press 105 may be configured with a cylindrical internal diameter configured to envelop the thermoplastic composite fiber tubular 101 and an internal diameter support 103. Because the press 105 operates in circular environment, the press 105 for the outer diameter (OD) of the thermoplastic composite fiber tubular 101 may be segmented so that its diameter may change during the pressing process. In some implementations, the press 105 may comprise collet-like segments that move together as the tubular 101 is squeezed. At the final squeeze, the collet-like fingers meet to form a continuous circle. The press 105 may be configured to press the thermoplastic composite fiber tubular 101 at both ends to form a male thread and a female thread.

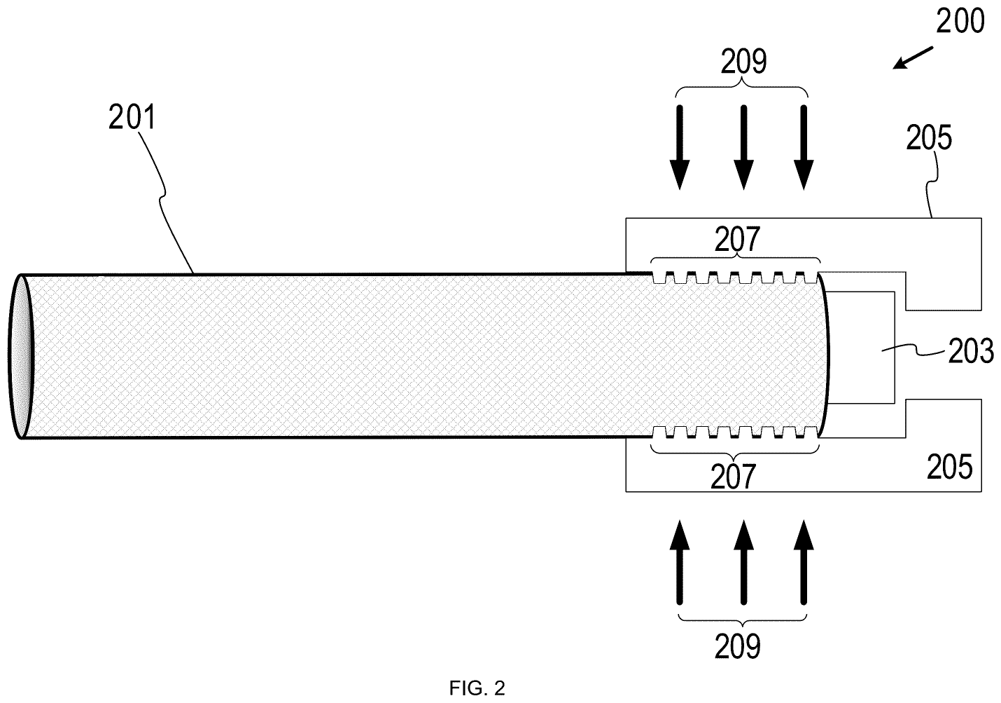

The internal diameter support 103 may be positioned within the thermoplastic composite fiber tubular 101 to provide internal structural support. In some implementations, the internal diameter support 303 may be a mandrel or a similar cylindrical structure of a smaller radius than the thermoplastic composite fiber tubular 101. The thermoforming process is described in further detail in FIG. 2.

FIG. 2 is a schematic diagram 200 depicting an example thermoplastic composite fiber tubular with thermoformed threads, according to some implementations. A thermoplastic composite fiber tubular 201 may be similar to the thermoplastic composite fiber tubular 101 of FIG. 1, an internal diameter support 203 may be similar to the internal diameter support 103 of FIG. 1, and a press 205 coupled to a toothed mold 207 may be similar to the press 105 and toothed mold 107 of FIG. 1. In FIG. 2, the press 205 has compressed the toothed mold 207 into an end of the thermoplastic composite fiber tubular 201 to form the threads. When the toothed mold 207 is pressed into the thermoplastic composite fiber tubular 101, the composite (fibers, matrix, and binder) comprising the thermoplastic composite fiber tubular 201 is consolidated through application of a compressive force 209 to ensure proper cohesion of the matrix and the fibers. The compressive force 209 may also remove inter-and intra-ply porosity. The fibers within the thermoplastic composite fiber tubular 201 may shift within the melted binder/polymer to make room for the newly formed threads. While the press 205 is depicted as clamping a top side and bottom side of the tubular 201, the press 205 is configured to circumferentially surround the tubular 201 to form the threads around the end of the thermoplastic composite fiber tubular 201.

In other implementations, the toothed mold 207 may be heated and rotated onto the thermoplastic composite fiber tubular 201, similar to a tap or die. However, the compressive force 209 used to press the heated toothed mold 207 into the thermoplastic composite fiber tubular 201 during the rotation may be configured to avoid creating deep cuts into the tubular 201. For example, the heated, rotating toothed mold 207 (in tandem with the press 205) may be configured to displace the composite material of the tubular 201 without removing greater than 25% of the material in the threads. Unlike a tap used to cut into metal, the heated, rotated toothed mold 207 may not significantly cut the tubular 201 during the thermoforming of the threads.

As discussed prior, the toothed mold 207 and press 205 may be heated prior to applying the compressive force 209 to the thermoplastic composite fiber tubular 201. The heat may soften or melt the thermoplastic binder of the thermoplastic composite fiber tubular 201. Softening the thermoplastic binder may allow and end of thermoplastic composite fiber tubular 201 to more easily deform when pressed. The toothed mold 207 may be heated to a temperature above the melting temperature of the composite or above the glass transition temperature of the composite. Ideally, the temperature of the heated, toothed mold 207 may be between the melt temperature and the glass transition temperature of the thermoplastic composite fiber tubular 201. In some implementations, the thermoplastic composite fiber tubular 201 is instead pre-heated and the toothed mold 207 remains at an ambient temperature during the thermoforming process. In this implementation, the (relatively) cool, toothed mold 207 may result in a more rapid cooling of the formed threads on the thermoplastic composite fiber tubular 201. In either implementation, the final threads are formed on the thermoplastic composite fiber tubular 201 after the threads have been cooled and the composite re-solidified. The rate of the cooling of the composite may be adjusted to, for example, to control a degree of crystallinity within the matrix of the thermoplastic composite fiber tubular 201. In some implementations, the crystallinity within the matrix may be augmented through various additive types and their concentrations for a set material through thermal treatments. Plasticizers including, but not limited to various phthalates, phosphates, and esters may be used to decrease the crystallinity of the matrix by increasing the spacing between chains of crystalline polymer, thus making the matrix more flexible and durable. Changes to various annealing conditions including, but not limited to adjusting heat ramp setpoints, adjusting a soak duration, and adjusting the cooling rate may all influence the crystallinity within the matrix.

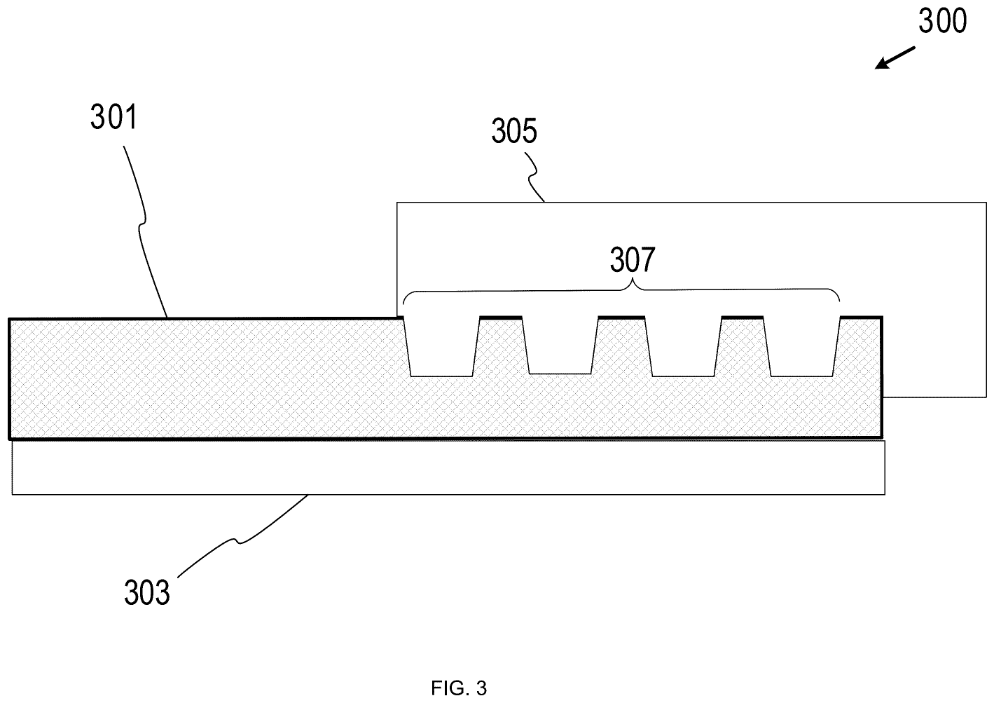

FIG. 3 is a schematic diagram 300 depicting a tight view of the thermoforming process to form the threads, according to some implementations. A composite tubing wall 301 may be pressed by a press 305. A toothed mold 307 comprising one or more teeth may be impressed into the composite tubing wall 301. An internal diameter support 303 may be similar to the internal diameter support 103 of FIG. 1. The internal diameter support 303 may provide stability to the composite tubing wall 301 during the thermoforming. The internal diameter support 303 may also act as a surface for the toothed mold 307 to squeeze against when creating the threads. The internal diameter support 303 may also mitigate a collapse or fracture of the composite tubing wall 301 during the thermoforming of the threads.

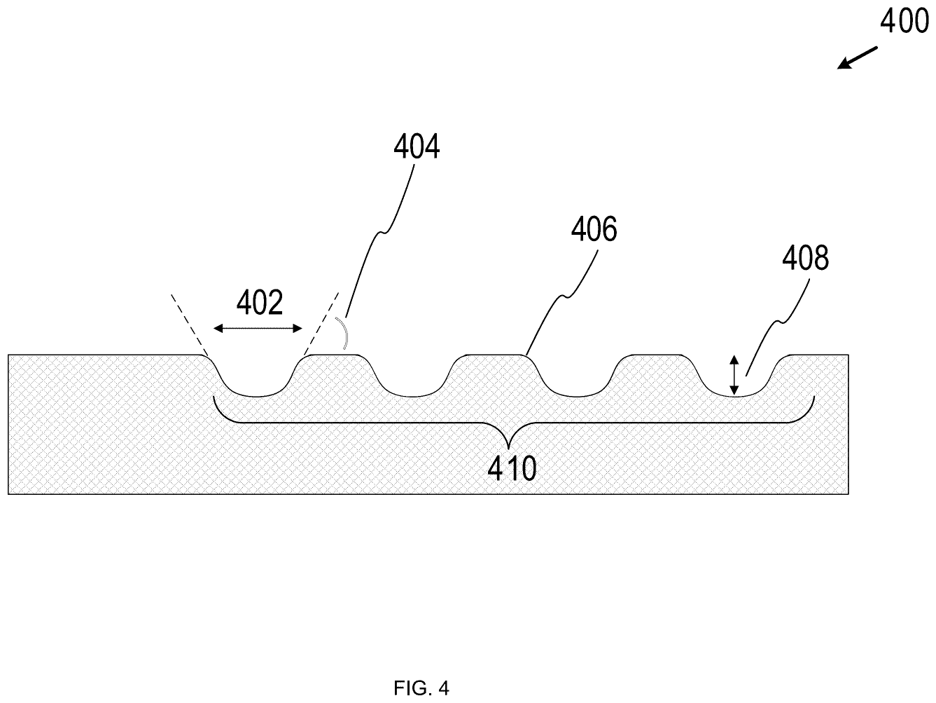

FIG. 4 is a schematic diagram depicting the thermoformed threads of FIG. 3, according to some implementations. A composite tubing wall 400 may comprise a plurality of thermoformed threads 410 created during the thermoforming process. The thermoformed threads 410 may each comprise a thread space 402, a draft angle 404, a radius 406, and a thread depth 408. In some implementations, the draft angle 404 of the thermoformed threads 410 may be less than 88° and preferably between 40° and 60°. The thread space 402 may preferably be longer than the thread depth 408.

Threads created through thermoforming, such as the thermoformed threads 410, may comprise a different shape than traditional threads created through cutting and/or machining. Cut threads, for example, may often include sharp angles which may induce fiber breakage. The thermoformed threads 410 may instead comprise a more rounded shape. The round shape may avoid any dovetailing of the threads when pressed. Sharp angles may also make it difficult for fibers within the composite to move within the thermoplastic binder during thermoforming.

The rounded corners of the thermoformed threads 410 may include the radius 406. In some implementations, the radius 406 may be approximately the length of thread space 402 or the thread depth 408. In some implementations, the draft angle 404 may not be symmetrical across each thermoformed thread. For example, a tube-facing side of the threads 410 (in FIG. 4, the left side of each of the thermoformed threads 410) may comprise a steeper draft angle 404. The steeper angle on the tube-facing side may enhance a seal formed with another tubular.

In some implementations, the thermoformed threads 410 may be configured as parallel threads of equal depth. In other implementations, the thermoformed threads 410 may be configured as tapered threads which gradually reduce in diameter towards the end of the composite tubing. In some implementations, the thermoformed threads 410 may be oriented or aligned with a feature on the tubing so the thermoformed threads 410 may extend to a point of final makeup with a second tubular. In some implementations, the thermoforming may be timed to form the threads along the composite tubing at the point of final makeup of the threaded connection so that there is a precisely know number of rotations and final angle in final makeup of the composite tubing. As a result, a feature on section joint of tubing would align with a mating feature on a second section of tubing. Aligning mating features allows for the easier completion of the wellbore with features that extend beyond one section of tubing, such as features to aid running electrical lines, hydraulic lines, hollow tubes, and shunt tubes.

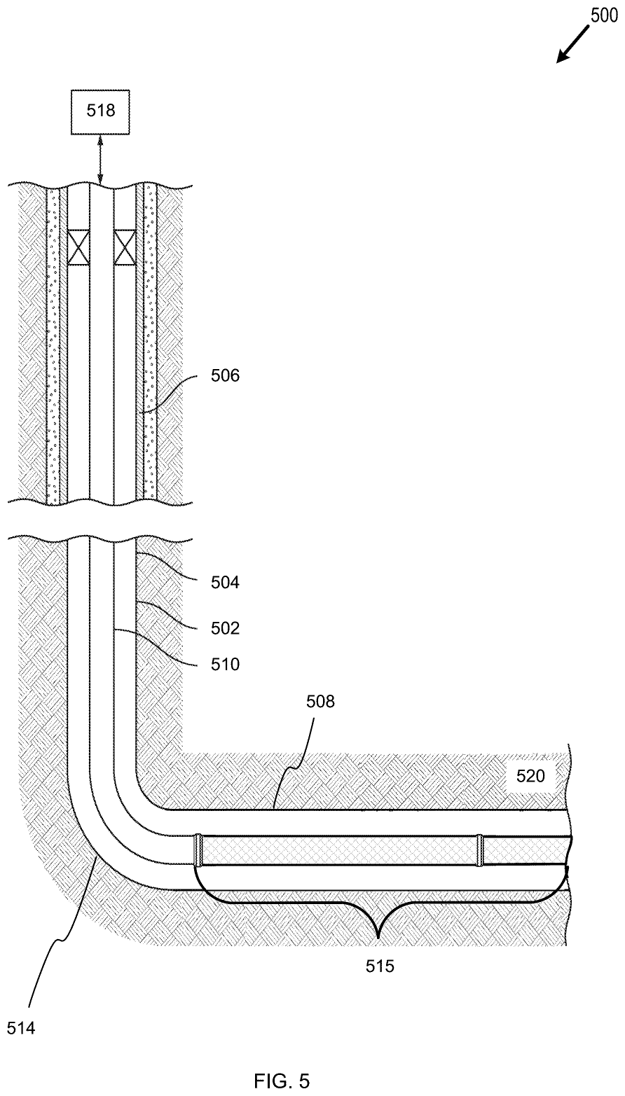

FIG. 5 is a cross-sectional diagram depicting an example wellbore comprising a tubing string partially constructed of thermoplastic composite tubing, according to some implementations. A well system 500 may comprise a wellbore 502 which intersects a subsurface formation 520. The wellbore 502 may include a vertical section 504 (which is at least partially cemented with a casing string 506) and a horizontal section 508. The horizontal section 508 may be an open-hole section of the wellbore 502. Other wellbore configurations may also be suitable.

Positioned within the wellbore 502 and extending from the surface is a first tubing string 510 which provides a conduit for formation fluids to travel from the subsurface formation 520 to the surface and for stimulation fluids to travel from the surface to the subsurface formation 520. For the purpose of example, the first tubing string 510 may be comprised of steel and may be coupled to a second tubing string 515. The second tubing string 515 may be comprised of thermoplastic composite fiber tubing similar to the thermoplastic composite fiber tubular 101 of FIG. 1. However, other materials and configurations may be possible. The first tubing string 510 and second tubing string 515 may comprise a greater or lesser proportion of the overall tubing than portrayed in FIG. 5.

In some implementations, at least a portion of a lower completion system may be comprised from composite tubing to enable an extended reach into a lateral (horizontal) wellbore. Conventional steel tubing used in oil and gas wells may comprise a density greater than a wellbore fluid in the wellbore 502. This increased density may culminate in a larger weight of the first tubing string 510 that must be supported by surface equipment 518, both in conveying the tubing into the wellbore 502 (e.g., a crane, drilling rig, workover rig, etc.) and supporting the weight of the first tubing string 510 once emplaced (e.g., tubing hangers, the wellhead, etc.). Thus, larger, more robust (and often more expensive) surface equipment 518 may be used to suspend the first tubing string 510 when steel is used. The first tubing string 510 may also require centralizers and other equipment to maintain centrality within the horizontal section 508. Otherwise, the denser first tubing string 510 may lay flat along the bottom of the horizontal section 508.

The second tubing string 515 which, in the above example is comprised of a thermoplastic composite, may comprise different material qualities. The second tubing string 515 may comprise a lower density than the first tubing string 510 comprised of steel, and this lower density may, in some implementations, be approximately equal (i.e., ±4 ppg) to the wellbore fluid in the horizontal section 508. For example, in 12 pound per gallon (ppg) brine, the second tubing string 515 comprised of the thermoplastic composite may possess an approximately neutral density to the brine. In some implementations where the wellbore fluid is water, the second tubing string 515 may weigh approximately 10% of a comparable steel tubing string. In some implementations, the second tubing string 515 comprised of the thermoplastic composite may be partially buoyant within the wellbore fluid in the horizontal section 508. The second tubing string 515 may be more centralized in the horizontal section 508 because of this partial buoyancy. However, in some implementations, centralizers (comprised of composite, plastic, or a similar polymer) may be used along the second tubing string 515 to aid fluid circulation around the thermoplastic composite tubing. The buoyancy, lower weight, and lower density thermoplastic composite of the second tubing string 515 (when compared to steel) may enable a lower completion to extend further into the horizontal section 508 or a similar extended reach horizontal wellbore.

A limiting factor in the length of producing lateral wellbore intervals is how far the tubing strings 510 and 515 are capable of extending into the horizontal section 508. The weight and density of a steel tubing string may present substantial frictional forces when moving through a heel 514 and horizontal section 508 of the wellbore 502. However, a tubing string with a lower portion comprised of thermoplastic composite tubulars may lessen the frictional forces in the wellbore 502, effectively allowing the second tubing string 515 comprised of thermoplastic composite fiber tubing joints to be pushed further into the horizontal section 508. A joint of tubing may refer to an individual tubular in the tubing string. In some implementations, the weight of the first tubing string 510 comprised of steel may assist in extending the thermoplastic composite tubing into the horizontal section 508. Thus, the frictional forces along the horizontal section 508 that may typically halt a steel tubing string dragging along the bottom (and being pushed by the surface equipment 518) may not hinder a thermoplastic composite fiber tubing string extending into the lateral section to the same extent.

Two example tubing strings are now described to convey the density and weight differences described above. A carbon fiber composite may be used for the second tubing string 515, and this material has a density of 1.55 grams per cubic centimeter (g/cc). Steel comprises a density of 7.85 g/cc. When submerged in water, the carbon fiber composite may comprise a relative density of 0.55 g/cc while the steel would comprise a relative density of 6.85 g/cc. Thus, a carbon fiber composite tubular would weigh ˜12× less than a comparable steel tubular. In some implementations, the lighter weight and decreased density of the second tubing string 515 may allow a lower completion to be installed using a smaller rig than would be used to convey a traditional steel completion. Since a strong rig is not required for installing a composite fiber completion, the composite fiber completion may be installed via wireline. In some implementations, the composite fiber lower completion may be pumped into position via one or more pumps as part of the surface equipment 518.

Thermoplastic composite fiber production tubing may allow for the use of traditional oilfield components and equipment without the weight and corrosion potential attributed to steel tubing. In some implementations, the second tubing string 515 comprised of thermoplastic fiber composite may be included as part of a permanent completion system in the wellbore, the completion system including, but not limited to straight tubing, sand screen assemblies, one or more slotted liners, control valves, safety valves, packers, and other completions tools. In some implementations, the sand screen assemblies and select tools may also be created from thermoplastic composite tubing. A lower completion created from thermoplastic composite tubing may increase the length of the tubing string that may be installed into an extended reach horizontal well.

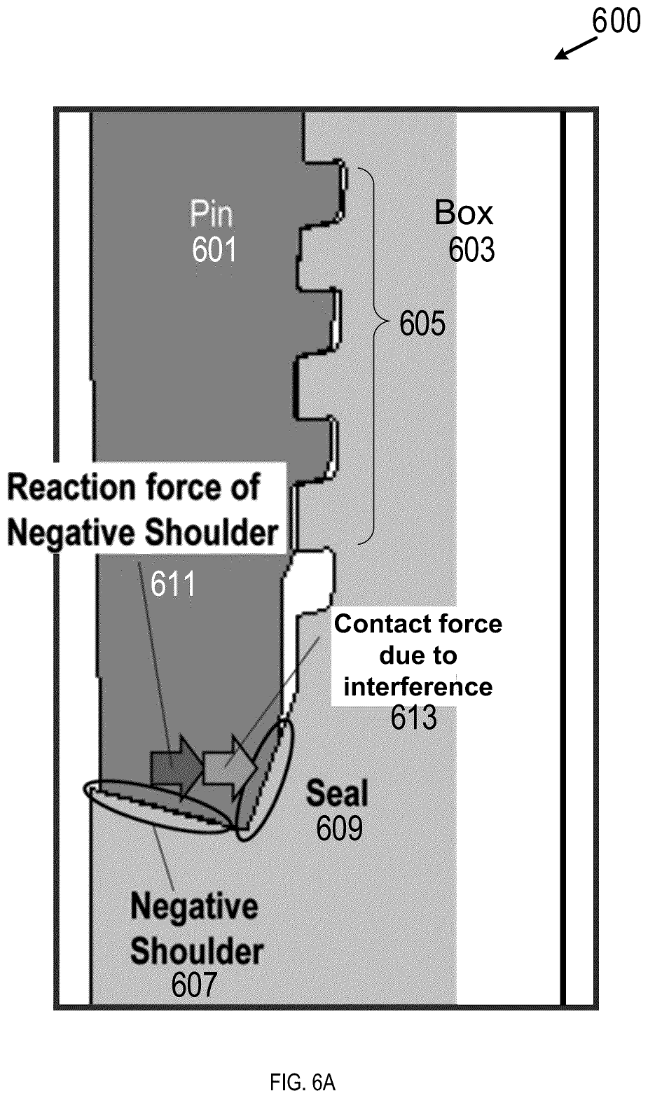

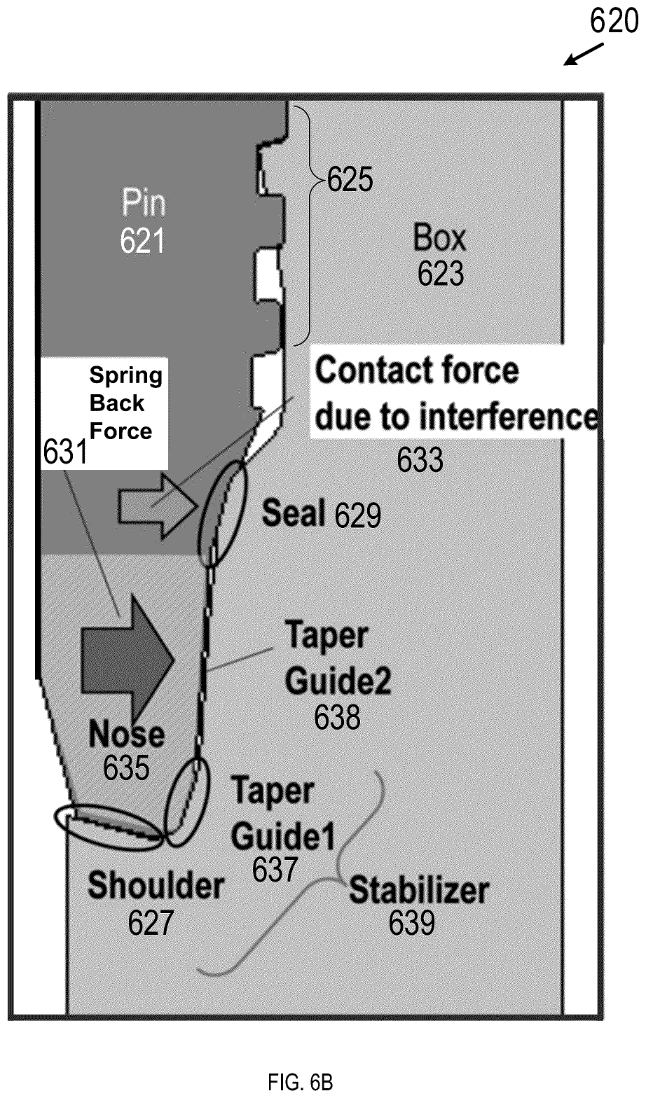

FIG. 6A is an illustration depicting a first example threaded connection 600 between two thermoplastic composite fiber tubulars, according to some implementations. A pin 601 may comprise a plurality of threads 605 and may be coupled with a box 603 during the formation of a threaded connection between two thermoplastic composite fiber tubing joints. The box 603 may be included on a first tubular and includes the male connection while the pin 601 may be included on a second tubular and includes the female connection. For example, the tubulars making the threaded connection 600 may be similar to the thermoplastic composite fiber tubular 101 of FIG. 1. During makeup of the threaded connection 600, the pin 601 may make contact with a negative shoulder 607 of the box 603. To enhance a pressure seal of the threaded connection 600, a seal 609 may be formed at the tip of the pin 601 between the pin 601 and box 603 along a thermoformed sealing interface. A high contact pressure between the box 603 and pin 601 may be needed to engage the seal 609. A contact force 613, generated due to a difference in seal diameter between the pin 601 and box 603, may increase the sealing capability of the seal 609. The angle of the negative shoulder 607 may direct a reaction force 611 of the negative shoulder into the box 603, thus enhancing the seal 609. In some implementations, a cutting face along the seal 609 and negative shoulder 607 may enhance the seal 609. While the threaded connection 600 may maintain a pressure seal under high compression, this seal configuration may fail to form an effective seal 609 under high tension.

FIG. 6B is a schematic diagram depicting a second example threaded connection 620 between two thermoplastic composite fiber tubulars, according to some implementations. A pin 621 and a box 623 may be similar to the pin 601 and box 603 of FIG. 6A, respectively. The pin 621 may comprise a plurality of threads 625. While the threaded connection 600 forms the seal 609 at the tip of the pin 601, the threaded connection 620 forms a seal 629 at a tapered torque shoulder between the pin 621 and box 623. A contact force 633, formed due to a difference in seal diameter between the pin 621 and box 623, may enhance the seal 629.

In some implementations, a nose 635 may be thermoformed as an extension of the pin 621. The nose 635 may be formed to be compliant and form a compressive seal with the box 623 during the makeup of the threaded connection 620. The nose 635 may also be formed with an increased flexibility which makes it more robust to variations in machining tolerances. The nose 635 may enhance the pressure sealing of the seal 629 when forming the threaded connection 620. For example, the nose 635 may enable a larger sealing interface between the box 623 and pin 621 (e.g., along a first taper guide 637, second taper guide 638, and the seal 629).

In some implementations, the nose 635 may include a stabilizer 639. The stabilizer 639 may consist of a negative-angled torque shoulder where the tip of the nose 635 meets the box 623. The stabilizer may also include the first taper guide 637 located near the shoulder 627. The stabilizer 639 may restrain radial deformation of the nose 635 under large compressive loads, thus stabilizing any compressive deformation of the nose 635. The second taper guide 638 may also be positioned between the pin 621 and box 623 during makeup of the threaded connection 620. The second taper guide 638 may be compressed by a spring back force 631. The spring back force 631 may be generated by a stiffness of the nose 635 and may amplify the sealing pressure of the seal 629.

In some implementations, the first taper guide 637 and second taper guide 638 may be configured as stabbing guides to mitigate damage to the seal 629 during makeup of the threaded connection 620. The first and second taper guides 637, 638 may be thermoformed in addition to the threads 625, shoulder 627, the seal 629, and the nose 635. A toothed mold such as the toothed mold 207 of FIG. 2 may be configured with additional sections to form the taper guides 637-638, shoulder 627, seal 629, threads 625, nose 635, and other sealing surfaces during thermoforming. In some implementations, the threaded connection 620 and location of the seal 629 may maintain a high sealing integrity even when repeatedly subject to large loads.

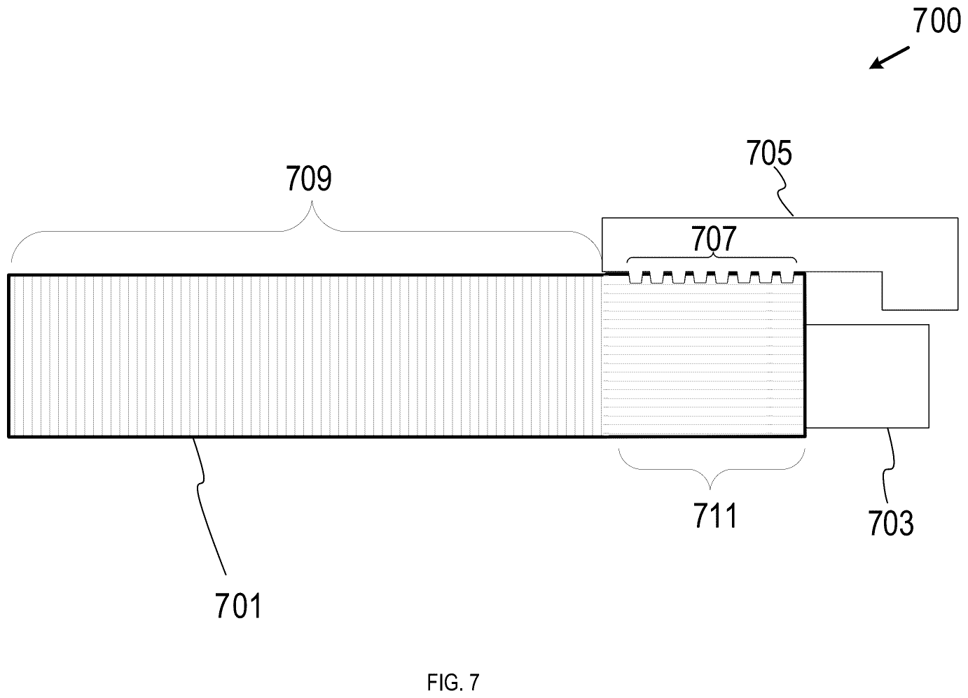

FIG. 7 is a schematic diagram 700 depicting an example thermoplastic composite fiber tubular with thermoformed threads comprising various fiber orientations, according to some implementations. A thermoplastic composite fiber tubular 701 may be similar to the thermoplastic composite fiber tubular 101 of FIG. 1. The thermoplastic composite fiber tubular 701 may be placed within a press 705 including a toothed mold 707 and an internal diameter support 703. A first fiber orientation section 709 may include one or more continuous fibers laid in an orientation toward expected stresses. For example, the thermoplastic composite fiber tubular 701's relatively light weight may generate lower tensile stresses (and thus a lower tensile strength requirement) in a composite tubing string than those of a steel tubing string. Thus, the fibers within the first fiber orientation section 709 may be laid in a high angle orientation within the composite to maximize burst and collapse strengths of the thermoplastic composite fiber tubular 701. In some implementations, the fibers may be oriented in a circumferential direction with a fiber angle greater than approximately 45°. In other implementations, the fibers may be oriented in a circumferential direction with a fiber angle greater than approximately 70 degrees where 90 degrees is the purely circumferential direction.

In some implementations, a second fiber orientation section 711 may comprise a fiber orientation different from the first fiber orientation section 709. The second fiber orientation section 711 may utilize a fiber orientation that influences the material properties of the threads. For example, the first fiber orientation section 709 may include fibers oriented in the radial direction while fibers in the second fiber orientation section 711 may be laid parallel to an axial direction of the tubular 701. The threads may be thermoformed onto the second fiber orientation section 711, and the axially-oriented fibers may provide more stability to the threads than the radially-oriented fibers used in section 709. In other implementations, the fibers may be oriented at an angle that approximately matches (.e.g., +25%) the draft angle of the threads, similar to the draft angle 404 of FIG. 4. In some implementations, the orientation of the fibers may be altered at locations where threads may be added.

### Alternate Implementations

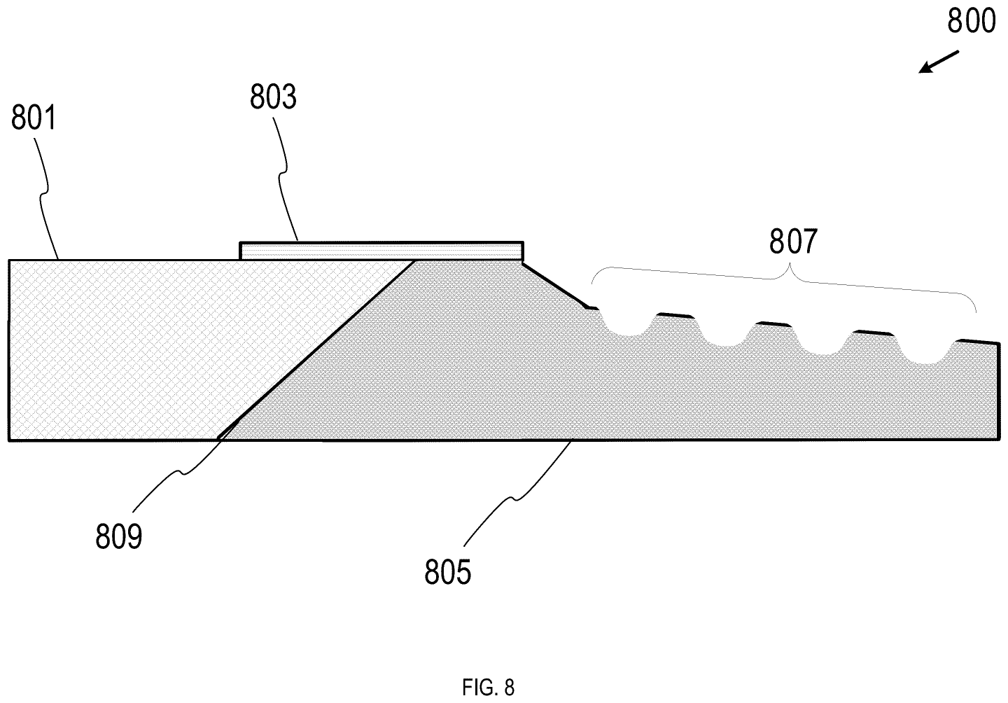

Some implementations may use differing fiber lengths and alternate composite tubing configurations. FIG. 8 is a cross-sectional diagram 800 depicting an example short-fiber composite, according to some implementations. In particular, the cross-sectional diagram 800 depicts a side-view through a wall of one or more tubulars. A long-fiber thermoplastic composite fiber tubular 201 801 may comprise one or more long, continuous fibers, similar to the thermoplastic composite fiber tubular 101. The long-fiber thermoplastic composite fiber tubular 801 may be coupled to a molded short-fiber composite 805 comprising shorter, chopped fibers. The short fibers may be set within and bound to a thermoplastic matrix. In some implementations, the molded short-fiber composite 805 may be formed via an injection molding process.

The chopped fibers may make the molded short-fiber composite 805 less brittle than a similar long-fiber composite tubular, and the molded short-fiber composite 805 may be able to sustain higher strain forces until failure when compared to a long-fiber composite. Thus, to avoid brittle fractures during the makeup of two joints of composite tubing, the molded short-fiber composite 805 may be used at connection points (i.e., the ends) between joints of composite tubing. The molded short-fiber composite comprises one or more threads 807 used to make the connection. The threads 807 may be configured as parallel or tapered, and the threads 807, in some implementations, may also be created during the injection molding process. In other implementations, the threads 807 may be thermoformed onto the molded short-fiber composite 805.

In some implementations, a brace 803 may be placed across a joint 809 between the long-fiber thermoplastic composite fiber tubular 801 and the molded short-fiber composite 805. In other implementations, the long-fiber thermoplastic composite fiber tubular 801 and the molded short-fiber composite 805 may be joined via a scarf cut, a lap joint, or any other suitable joint. As depicted, the joint 809 is a lap joint. The joint 809 may be formed by heating the composite in the long-fiber tubular 801, short-fiber composite 805, or both to create melt the binder and create the bond once cooled. The brace 803 may provide lap strength between the long-fiber tubular 801 and the molded short-fiber composite 805. The brace 803 may also provide a location for tongs or similar equipment to grab the tubing joint formed by the long-fiber thermoplastic composite fiber tubular 801 and the molded short-fiber composite 805. The tongs may lock around the brace 803 when forming connections between thermoplastic composite fiber tubulars.

The brace 803 may act as a sacrificial layer that may receive any damage inflicted by the tongs, sparing the tubing within from damage. The brace 803 may serve an additional function of supporting a pressure load on the short-fiber composite 805 and threads 807.

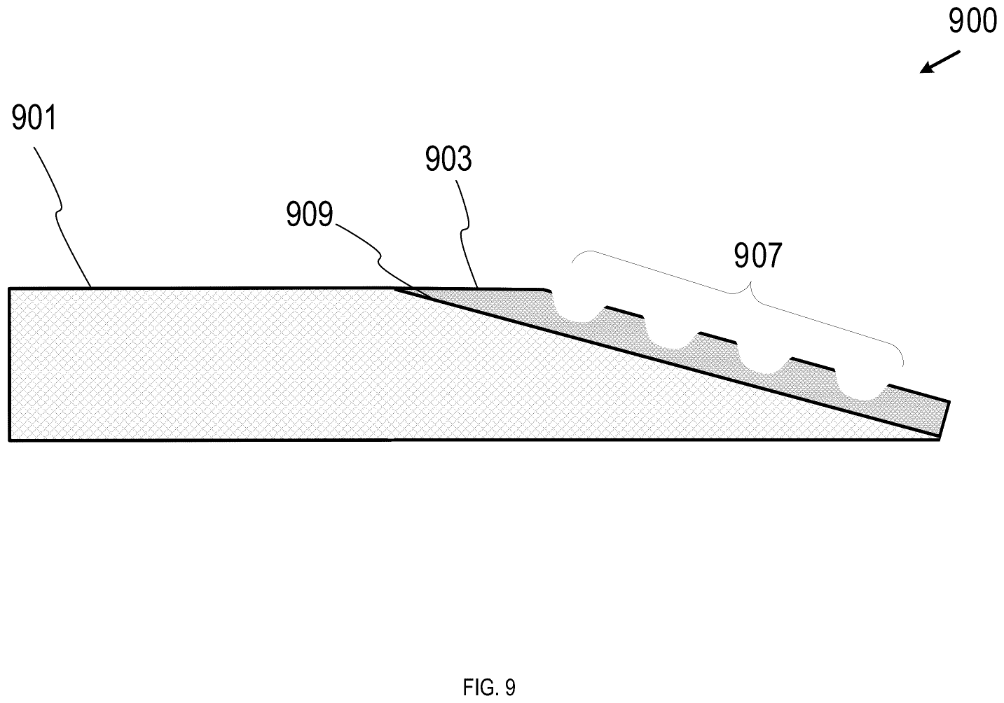

FIG. 9 is a cross-sectional diagram 900 depicting an example molded short-fiber insert, according to some implementations. A molded short-fiber insert 903 may be coupled to a long-fiber thermoplastic composite fiber tubular 901. While the molded short-fiber composite 805 of FIG. 8 is a separate piece tubular, the molded short-fiber insert 903 is a thin layer of material comprising threads 907 and circumferentially affixed to the long-fiber thermoplastic composite fiber tubular 901. The molded short-fiber insert 903 may be joined to the long-fiber thermoplastic composite fiber tubular 901 at a joint 909 which may be similar to the joint 809 of FIG. 8. As depicted, the molded short-fiber insert 903 is a thin layer of threads 907 atop a scarf cut.

Regarding both FIGS. 8-9, the short fibers may comprise an isotropic orientation. However, in some implementations, the short fibers may also be configured in an anisotropic orientation. For example, the short-fiber composite 805 and the molded short-fiber insert 903 may be created through an injection molding process, and the use of a smaller nozzle may align the short fibers upon exiting the nozzle. In some implementations, the molded short-fiber insert 903 may be 3D printed. A suitable 3D printer may be configured to print the threads and matrix comprising the short-fiber insert 903. The short fibers may be aligned in a single direction when exiting the 3D printer nozzle. The 3D printer may extrude a heated (i.e., melted) thermoplastic binder, such as PEEK, with chopped fibers suspended within. However, other materials and configurations may be possible. The extrusion may be considered a form of thermoforming, as heat is utilized to deform and shape the thermoplastic binder and fibers into threads. In some implementations, long, continuous fibers such as those used in the first fiber section 709 of FIG. 7 may also be 3D printed.

### Example Flowchart

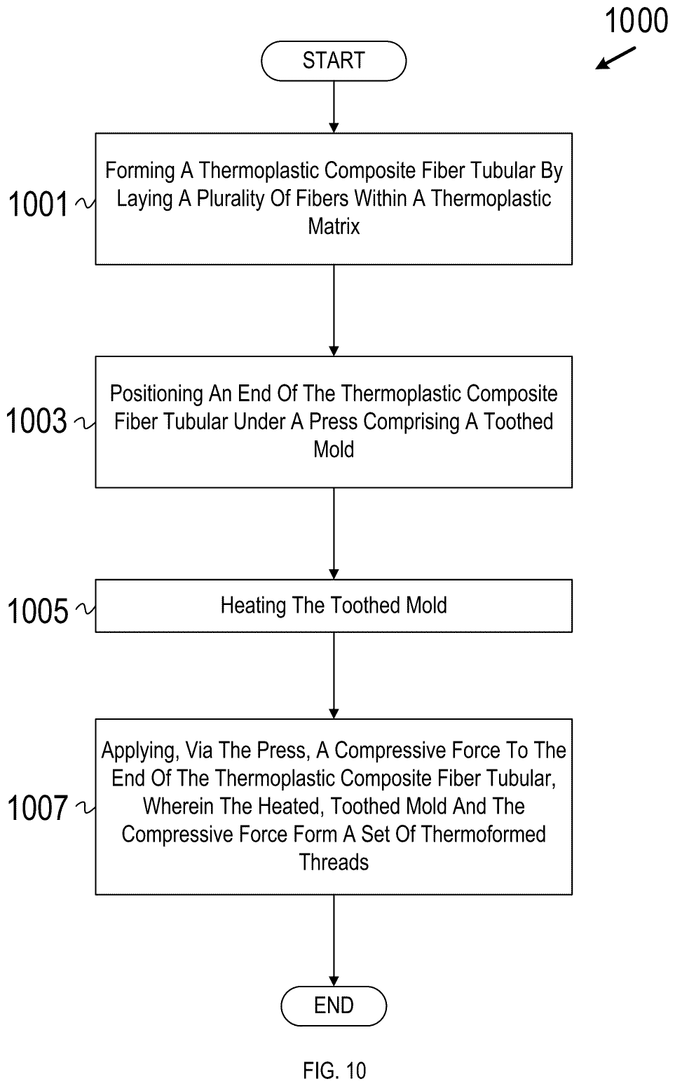

FIG. 10 is a flowchart depicting example operations for thermoforming threads onto a thermoplastic composite fiber tubular to be used in a wellbore, according to some implementations. Operations of a method 1000 may be performed in part by software, firmware, hardware, or a combination thereof. Such operations are described with reference to FIGS. 1-9. However, such operations may be performed by other systems or components. The operations of the method 1000 begin at block 1001.

At block 1001, the method 1000 includes forming a thermoplastic composite fiber tubular by laying a plurality of fibers within a thermoplastic matrix. For example, with reference to FIG. 1, the thermoplastic composite fiber tubular 101 may be formed by laying a plurality of long, continuous fibers within a thermoplastic matrix. The matrix may be bound to the fibers via a thermoplastic binder. In other implementations, the matrix be applied to the fibers prior to creating the thermoplastic composite fiber tubular 101 (e.g., a pre-impregnation) or during its fabrication. Flow progresses to block 1003.

At block 1003, the method 1000 includes positioning an end of the thermoplastic composite fiber tubular under a press comprising a toothed mold. For example, with reference to FIG. 1, an end the thermoplastic composite fiber tubular 101 may be positioned under the press 105 including the toothed mold 107. Flow progresses to block 1005.

At block 1005, the method 1000 includes heating the toothed mold. For example, with reference to FIG. 2, the toothed mold 207 is heated to a temperature above the melting temperature of the thermoplastic composite or above the glass transition temperature of the thermoplastic composite. Ideally, the toothed mold 207 may be heated to a temperature between the melting temperature and the glass transition temperature of the thermoplastic composite fiber tubular 201 prior to forming the threads. Flow progresses to block 1007.

At block 1007, the method 1000 includes applying, via the press, a compressive force to the end of the thermoplastic composite fiber tubular, wherein the heated, toothed mold and the compressive force form a set of thermoformed threads. For example, with reference to FIG. 2, the press 205 applies a compressive force 209 to press the toothed mold 207 (when heated) into an end of the thermoplastic composite fiber tubular 201. With reference to FIG. 4, this process results in the thermoformed threads 410. Flow of the method 1000 ceases.

### Example Implementations:

Implementation 1: An apparatus comprising: a thermoplastic composite fiber tubular to be positioned in a wellbore, the thermoplastic composite fiber tubular comprising, a thermoplastic matrix; a plurality of fibers laid within the thermoplastic matrix; and one or more threads thermoformed at an end of the thermoplastic composite fiber tubular, the one or more threads configured to form a threaded connection with another tubular in the wellbore.

Implementation 2: The apparatus of claim 1, wherein the thermoplastic matrix is comprised of a thermoplastic binder, wherein the thermoplastic binder is one of a non-reactive polymer, a thermoplastic elastomer, and a thermoplastic polyamide.

Implementation 3: The apparatus of claim 1, further comprising: a first section of the thermoplastic composite fiber tubular comprising a plurality of continuous fibers configured in a radial orientation; and a second section of the thermoplastic composite fiber tubular comprising a plurality of continuous fibers configured in an axial orientation, wherein the one or more threads are thermoformed onto the second section of the thermoplastic composite fiber tubular.

Implementation 4: The apparatus of claim 1, wherein the one or more threads are thermoformed via a toothed mold pressed into the thermoplastic composite fiber tubular, and wherein one of the toothed mold and the thermoplastic composite fiber tubular is heated to form the one or more thermoformed threads.

Implementation 5: The apparatus of claim 1, further comprising: a thermoformed negative shoulder proximate to the one or more threads; and a thermoformed sealing interface proximate to the thermoformed negative shoulder, wherein the thermoformed negative shoulder is configured to enhance a seal along the thermoformed sealing interface.

Implementation 6: The apparatus of claim 1, further comprising: a thermoformed nose proximate to the one or more threads; and a thermoformed sealing interface proximate to the thermoformed nose, wherein a stiffness of the thermoformed nose generates a spring back force when forming the threaded connection, wherein the spring back force enhances a seal along the thermoformed sealing interface.

Implementation 7: The apparatus of claim 1, further comprising: a short-fiber composite comprising the one or more threads and coupled to the thermoplastic composite fiber tubular; and a brace configured to span a joint between the thermoplastic composite fiber tubular and the short-fiber composite.

Implementation 8: The apparatus of claim 7, wherein the short-fiber composite comprises one of an injection-molded short-fiber composite and a 3D-printed short-fiber insert.

Implementation 9: A system comprising: a thermoplastic composite fiber tubing string to be positioned in a wellbore, the thermoplastic composite fiber tubing string comprising. a first thermoplastic composite fiber tubular comprising a first set of thermoformed threads; a second thermoplastic composite fiber tubular comprising a second set of thermoformed threads, wherein the first set of thermoformed threads is configured to form a threaded connection with the second set of thermoformed threads; and a downhole completion tool to be positioned in the wellbore, the downhole completion tool coupled to one of the first thermoplastic composite fiber tubular and the second thermoplastic composite fiber tubular.

Implementation 10: The system of claim 9, wherein the first thermoplastic composite fiber tubular and the second thermoplastic composite fiber tubular are comprised of a thermoplastic binder, wherein the thermoplastic binder is one of a non-reactive polymer, a thermoplastic elastomer, and a thermoplastic polyamide.

Implementation 11: The system of claim 9, wherein the first and second sets of thermoformed threads are formed via a heated, toothed mold pressed into the first thermoplastic composite fiber tubular and the second thermoplastic composite fiber tubular.

Implementation 12: The system of claim 9, further comprising: a negative shoulder thermoformed on the first thermoplastic composite fiber tubular and proximate to the first set of thermoformed threads; and a sealing interface thermoformed on the second thermoplastic composite fiber tubular and proximate to the thermoformed negative shoulder, wherein the thermoformed negative shoulder is configured to enhance a seal along the thermoformed sealing interface.

Implementation 13: The system of claim 9, further comprising: a nose thermoformed on the second thermoplastic composite fiber tubular; a negative shoulder thermoformed on to the first thermoplastic composite fiber tubular and proximate to the thermoformed nose; and a sealing interface thermoformed on the first thermoplastic composite fiber tubular and proximate to the thermoformed nose, wherein a stiffness of the thermoformed nose generates a spring back force, wherein the spring back force enhances a seal along the thermoformed sealing interface.

Implementation 14: The system of claim 9, further comprising: a short-fiber thermoplastic composite fiber tubular comprising the first set of thermoformed threads and coupled to the first thermoplastic composite fiber tubular; a brace configured to span a joint between the first thermoplastic composite fiber tubular and the short-fiber thermoplastic composite fiber tubular; and a molded short-fiber insert comprising the second set of thermoformed threads and coupled to the second thermoplastic composite fiber tubular.

Implementation 15: The system of claim 9, wherein the downhole completion tool is coupled to one of the first thermoplastic composite fiber tubular via the first set of thermoformed threads and the second thermoplastic composite fiber tubular via the second set of thermoformed threads.

Implementation 16: A method comprising: constructing a thermoplastic composite fiber tubular including a set of thermoformed threads to be positioned in a wellbore, the constructing comprising, laying a plurality of fibers within a thermoplastic matrix to form the thermoplastic composite fiber tubular; positioning an end the thermoplastic composite fiber tubular under a press comprising a toothed mold; and heating the toothed mold; and applying, via the press, a compressive force to the end of thermoplastic composite fiber tubular, wherein the heated, toothed mold and the compressive force form the set of thermoformed threads.

Implementation 17: The method of claim 16, further comprising: positioning an internal diameter support within the thermoplastic composite fiber tubular and proximate to the end of the tubular, wherein the internal diameter support prevents collapse and fracture damage to the thermoplastic composite fiber tubular during the application of the compressive force to form the set of thermoformed threads.

Implementation 18: The method of claim 16, further comprising: heating the thermoplastic composite fiber tubular, wherein the toothed mold and the compressive force form the set of thermoformed threads in the heated thermoplastic composite fiber tubular.

Implementation 19: The method of claim 16, further comprising: thermoforming a compliant nose at the end of the thermoplastic composite fiber tubular, wherein the compliant nose is compressed to form a seal within a threaded connection with a second tubular.

Implementation 20: The method of claim 19, further comprising: thermoforming each thread of the set of threads to have a draft angle between 40 and 60 degrees, wherein one side of each thread comprises a steeper draft angle to enhance the seal with the second tubular.

What is claimed is:

1. An apparatus comprising:
a thermoplastic composite fiber tubular to be positioned in a wellbore, the thermoplastic composite fiber tubular comprising,
a thermoplastic matrix;
a plurality of fibers laid within the thermoplastic matrix; and
one or more threads thermoformed at an end of the thermoplastic composite fiber tubular, the one or more threads configured to form a threaded connection with another tubular in the wellbore.

2. The apparatus of claim 1, wherein the thermoplastic matrix is comprised of a thermoplastic binder, wherein the thermoplastic binder is one of a non-reactive polymer, a thermoplastic elastomer, and a thermoplastic polyamide.

3. The apparatus of claim 1, further comprising:
a first section of the thermoplastic composite fiber tubular comprising a plurality of continuous fibers configured in a radial orientation; and
a second section of the thermoplastic composite fiber tubular comprising a plurality of continuous fibers configured in an axial orientation, wherein the one or more threads are thermoformed onto the second section of the thermoplastic composite fiber tubular.

4. The apparatus of claim 1, wherein the one or more threads are thermoformed via a toothed mold pressed into the thermoplastic composite fiber tubular, and wherein one of the toothed mold and the thermoplastic composite fiber tubular is heated to form the one or more thermoformed threads.

5. The apparatus of claim 1, further comprising:
a thermoformed negative shoulder proximate to the one or more threads; and
a thermoformed sealing interface proximate to the thermoformed negative shoulder, wherein the thermoformed negative shoulder is configured to enhance a seal along the thermoformed sealing interface.

6. The apparatus of claim 1, further comprising:
a thermoformed nose proximate to the one or more threads; and
a thermoformed sealing interface proximate to the thermoformed nose, wherein a stiffness of the thermoformed nose generates a spring back force when forming the threaded connection, wherein the spring back force enhances a seal along the thermoformed sealing interface.

7. The apparatus of claim 1, further comprising:
a short-fiber composite comprising the one or more threads and coupled to the thermoplastic composite fiber tubular; and
a brace configured to span a joint between the thermoplastic composite fiber tubular and the short-fiber composite.

8. The apparatus of claim 7, wherein the short-fiber composite comprises one of an injection-molded short-fiber composite and a 3D-printed short-fiber insert.

9. A system comprising:
a thermoplastic composite fiber tubing string to be positioned in a wellbore, the thermoplastic composite fiber tubing string comprising,
a first thermoplastic composite fiber tubular comprising a first set of thermoformed threads;
a second thermoplastic composite fiber tubular comprising a second set of thermoformed threads, wherein the first set of thermoformed threads is configured to form a threaded connection with the second set of thermoformed threads; and
a downhole completion tool to be positioned in the wellbore, the downhole completion tool coupled to one of the first thermoplastic composite fiber tubular and the second thermoplastic composite fiber tubular.

10. The system of claim 9, wherein the first thermoplastic composite fiber tubular and the second thermoplastic composite fiber tubular are comprised of a thermoplastic binder, wherein the thermoplastic binder is one of a non-reactive polymer, a thermoplastic elastomer, and a thermoplastic polyamide.

11. The system of claim 9, wherein the first and second sets of thermoformed threads are formed via a heated, toothed mold pressed into the first thermoplastic composite fiber tubular and the second thermoplastic composite fiber tubular.

12. The system of claim 9, further comprising:
a negative shoulder thermoformed on the first thermoplastic composite fiber tubular and proximate to the first set of thermoformed threads; and
a sealing interface thermoformed on the second thermoplastic composite fiber tubular and proximate to the thermoformed negative shoulder, wherein the thermoformed negative shoulder is configured to enhance a seal along the thermoformed sealing interface.

13. The system of claim 9, further comprising:
a nose thermoformed on the second thermoplastic composite fiber tubular;
a negative shoulder thermoformed on to the first thermoplastic composite fiber tubular and proximate to the thermoformed nose; and
a sealing interface thermoformed on the first thermoplastic composite fiber tubular and proximate to the thermoformed nose, wherein a stiffness of the thermoformed nose generates a spring back force, wherein the spring back force enhances a seal along the thermoformed sealing interface.

14. The system of claim 9, further comprising:
a short-fiber thermoplastic composite fiber tubular comprising the first set of thermoformed threads and coupled to the first thermoplastic composite fiber tubular;
a brace configured to span a joint between the first thermoplastic composite fiber tubular and the short-fiber thermoplastic composite fiber tubular; and
a molded short-fiber insert comprising the second set of thermoformed threads and coupled to the second thermoplastic composite fiber tubular.

15. The system of claim 9, wherein the downhole completion tool is coupled to one of the first thermoplastic composite fiber tubular via the first set of thermoformed threads and the second thermoplastic composite fiber tubular via the second set of thermoformed threads.

16. A method comprising:
constructing a thermoplastic composite fiber tubular including a set of thermoformed threads to be positioned in a wellbore, the constructing comprising,
laying a plurality of fibers within a thermoplastic matrix to form the thermoplastic composite fiber tubular;
positioning an end the thermoplastic composite fiber tubular under a press comprising a toothed mold; and
heating the toothed mold; and
applying, via the press, a compressive force to the end of thermoplastic composite fiber tubular, wherein the heated, toothed mold and the compressive force form the set of thermoformed threads.

17. The method of claim 16, further comprising:
positioning an internal diameter support within the thermoplastic composite fiber tubular and proximate to the end of the tubular, wherein the internal diameter support prevents collapse and fracture damage to the thermoplastic composite fiber tubular during the application of the compressive force to form the set of thermoformed threads.

18. The method of claim 16, further comprising:
heating the thermoplastic composite fiber tubular, wherein the toothed mold and the compressive force form the set of thermoformed threads in the heated thermoplastic composite fiber tubular.

19. The method of claim 16, further comprising:
thermoforming a compliant nose at the end of the thermoplastic composite fiber tubular, wherein the compliant nose is compressed to form a seal within a threaded connection with a second tubular.

20. The method of claim 19, further comprising:
thermoforming each thread of the set of threads to have a draft angle between 40 and 60 degrees, wherein one side of each thread comprises a steeper draft angle to enhance the seal with the second tubular.
